(19) United States
(12) Patent Application Publication
(10) Pub. No.: US 2014/0030456 A1
(43) Pub. Date: Jan. 30, 2014

(54) HEAT WELDABLE FILM FOR LABELLING PLASTIC POLYMER REACTION TUBES

(71) Applicant: Peter Anthony Collins, Wotton (GB)

(72) Inventor: Peter Anthony Collins, Wotton (GB)

(73) Assignee: 4TITUDE LTD, Wolton, Surrey (GB)

(21) Appl. No.: 14/110,071

(22) PCT Filed: Mar. 28, 2012
(86) PCT No.: PCT/EP12/01413

§ 371 Date: Oct. 7, 2013

(30) Foreign Application Priority Data
Apr. 7, 2011 (EP) 11161488.9

(51) Int. Cl. B32B 27/08; G06K 19/02

(52) U.S. Cl. CPC B32B 27/08; G06K 19/02; G06K 19/022
USPC 428/35.7; 428/349; 428/344; 428/335; 428/334; 235/488; 156/293

(57) ABSTRACT

The application discloses a heat weldable film comprising the flowing layers: (i) a first plastic polymer layer consisting of a material weldable to a plastic polymer reaction tube; (ii) an opaque second layer comprising pigments; (iii) a third layer consisting of a clear transparent material; wherein the material of the first and third layer differ. Furthermore, a reaction tube comprising a heat weldable film according to the invention is disclosed as well as a method for labelling of reaction tubes.

### TECHNICAL FIELD OF THE INVENTION

The present invention is in the field of laboratory consumables. Particularly it is in the field of labels for plastic polymer reaction tubes. More particularly the present invention is in the field of heat weldable films or foils weldable to plastic polymer reaction tubes.

### BACKGROUND OF THE INVENTION

Over the last decade, there has been a dramatic increase in the use of bar codes, especially two dimensional (2D) bar codes, for uniquely identifying products. In particular the small size of these 2D codes enables them to be used to label the base of reaction tubes in the life sciences industry.

There are currently a number of ways how this is achieved. A first method currently employed by a number of companies is to use a two-coat paint directly on the end of the tube, with a white undercoat and a black topcoat. This painted flat surface is then exposed to a laser beam and the black top paint is removed (or etched away) where it is hit by the laser light thus exposing the white material below. This gives the contrast of white and black dots, which makes up the code.

An alternative method is to take a laser etchable material to produce a black and white contrasting code. This label code is punched out in a ˜5-6 mm disk and then encased with a clear plastic cap onto the base of a micro tube and the cap is hermetically welded using an ultra sonic welding device.

An alternative method is to form the tube using a two-shot moulding process. Using this process the main body of the tube is moulded of a standard polypropylene, and then the base of the tube is moulded of a second black material that is sensitive to laser marking. A further development of this design is a complete sleeve made of the second black material that not only covers the base but also the body of the tube.

However, all of the methods to label plastic polymer reaction tubes are complicated to produce and—due to the amount of material needed—costly. The problem underlying the present invention is to provide a composition to label plastic polymer reaction tubes. One aspect is the provision of a durable label for plastic polymer reaction tubes.

### Description of the Invention

The inventors unexpectedly found that, by using a film as described herein below, it is possible to simplify labelling of plastic polymer reaction tubes. Furthermore, the use of w such films decreases the costs tremendously.

Hence, the present invention relates to a heat weldable film comprising the following layers (i) a first plastic polymer layer consisting of a material weldable to a plastic polymer reaction tube; (ii) an opaque second layer comprising pigments; (iii) a third layer is consisting of a clear, transparent material; wherein the material of the first and third layer differ.

In one embodiment the present invention relates to a reaction tube comprising a heat weldable film according to the present invention, wherein the heat weldable film has been welded to the reaction tube, preferably at the bottom of the tube.

In a further embodiment the present invention relates to a microplate comprising a heat weldable film according to the present invention, wherein the heat weldable film has been welded to the microplate.

Furthermore the invention relates to a method for producing a bar-coded reaction tube comprising the steps of (i) providing a reaction tube (ii) placing the heat weldable film according to the present invention onto said reaction tube, wherein the first layer is faced towards the surface of the reaction tube; (iii) applying heat and pressure onto the heat as weldable film and/or the reaction tube for a time sufficient to weld the heat weldable film onto the reaction tube.

The present invention further relates to a method for producing a barcoded reaction tube comprising the steps of: (i) providing a reaction tube comprising a cavity at least partially surrounded by a rim; (ii) placing the heat weldable film according to the present invention into said cavity, wherein the first layer is faced towards the surface of the reaction tube; (iii) applying heat and pressure onto the heat weldable film and/or the reaction tube for a time sufficient to weld the heat weldable film onto the reaction tube.

### DETAILED DESCRIPTION OF THE INVENTION

The skilled artisan will recognize that by the provision of the heat weldable film according to the present invention an easy and efficient labelling of plastic polymer reaction tubes is allowed. The terms “plastic polymer reaction tubes” and “reaction tubes” are used interchangeably herein. In one embodiment of the invention the heat weldable film comprises a machine readable code. In a preferred embodiment the machine readable code is a 2D code.

In one embodiment of the present invention welding means the generation of a permanent bond between the weldable film according to the present invention and the plastic polymer reaction tube.

It will be appreciated by those of ordinary skills that the machine readable code may be applied on the heat weldable film by using different methods. However, the inventors unexpectedly found that the heat weldable film exhibits astonishing good properties in respect to laser marking. Hence, in a preferred embodiment of the present invention the machine readable code is created by means of laser technique. In a yet further preferred embodiment the machine readable code is created by burning the code onto the second layer using laser techniques. The skilled artisan will recognize that due to the construction of the heat weldable film it is possible to burn the machine readable code onto the second layer through the third layer. Hence, it is possible to apply the label codes after welding of the heat weldable film onto the plastic polymer reaction tube or microplate. Moreover, the skilled artisan will recognize that the code may also be burned onto the third layer of the heat weldable film according to the present invention. In this case the second layer serves as a background and contrast for the burned code to facilitate reading of the code.

The different layers and foils of the heat weldable film according to the present invention may be bound together by different means. The skilled artisan is aware of means to bind the different layers. However, in one embodiment of the present invention the layers are bound together via adhesives and/or heat lamination.

The inventors unexpectedly found that the application of a reflective toil between the first and the second layer further enhances the readability of the code. Hence, in one embodiment of the present invention the heat weldable film according to the present invention comprises a reflective foil between the first layer and the second layer. The foil is preferably reflective on the side directed towards the second layer of the heat weldable film. However, in one embodiment the reflective foil is reflective on both sides. The reflective foil may consist of different materials known by those of ordinary skills in the art. For example the foil may be a plastic polymer coated with a metallic layer, i.e. the metallic layer confers the reflective properties. However, in a preferred embodiment of the present invention the reflective foil consists of a material selected from the group comprising aluminium, copper, silver, gold, platinum, and metalized plastic films.

“Reflective” in the context with the present invention means that the surface reflects the light specular (mirror-like) or diffuse (retaining the energy, but losing the image).

In one embodiment the second layer is consisting of white pigment and applied onto the foil.

The thickness of the reflective foil may be selected according to the needs. However, in a preferred embodiment of the present invention the reflective foil has a thickness of between 0.001 mm and 0.05 mm, preferably of between 0.005 mm and 0.015 mm.

The material of the first layer may be chosen according to the needs. In context of the present invention the first layer confers the feature of heat weldability to the heat weldable film according to the present invention. Hence, the skilled artisan will acknowledge that the material of the first layer is weldable to a plastic polymer reaction tube through the application of heat. The skilled person is able to choose materials for the first layer. The material to be chosen may depend on the material of the plastic polymer reaction tube on which the heat weldable film has to be applied. In one embodiment of the present invention the material of the first layer is the same material as the material of the plastic polymer reaction tube on which the heat weldable film is welded or is to be welded.

However, in another embodiment the first layer consists of a material different to the material of the plastic polymer reaction tube on which the heat weldable film is welded or is to be welded. In one embodiment of the present invention the first layer consists of a material selected from the group consisting of polypropylene, polystyrene, polyethylene, cycloolefin polymer (COP), cycloolefin copolymer (COC).

The first layer may be of different thickness. The thickness of the first layer may be chosen according to the desired needs. However, in one embodiment of the present invention the first layer has a thickness of between 0.005 mm and 0.1 mm, preferably of between 0.01 mm and 0.030 mm.

The material of the third layer may be chosen according to the desired properties, preferably the material is rigid enough to protect the layers below. Furthermore, the third layer shall consist of a transparent, clear material. Thereby the readability of the machine readable code is assured. In a preferred embodiment of the present invention the third layer consists of a material selected from the group consisting of polyester, acrylic polymers and copolymers, vinyl halide polymers and copolymers, polycarbonates, and polyurethanes.

The thickness of the third layer may be adapted to the needs. For example if the heat weldable film shall be durable for a longer period, it is desirable to have a thicker third layer in order to have a greater buffer for abrasion. However, in one embodiment of the present invention the third layer has a thickness of between 0.001 mm and 0.1 mm, preferably of between 0.005 mm and 0.025 min.

The opaque second layer may comprise pigments that confer the opacity. The pigments may be chosen according to the desired colour and opacity. The skilled artisan will recognize that the pigments shall serve as a contrast to the machine readable code. The inventors unexpectedly found that a white pigmented opaque second layer is very well suited for machine readable codes which are applied by means of laser technique. Hence, in one embodiment of the present invention the second layer comprises white pigments, preferably a pigment comprising titan dioxide (TᵢO₂). In one embodiment the second layer is a layer of pigments directly applied below the third layer.

As outlined above, the plastic polymer of the first layer may consist of any material heat weldable to a plastic polymer reaction tube. The materials of the first layer of the heat weldable film and the plastic polymer of the reaction tube may in principle differ as long as they are heat weldable to each other. The inventors interestingly found that the heat weldable film can be easily welded to a plastic polymer reaction tube if the first layer of the heat weldable film and the material of the plastic polymer reaction tube are the same. Hence, in one embodiment of the present invention the material of the reaction tube and the material of the first layer of the heat weldable film are the same materials. In a further embodiment, the material of the first layer of the heat weldable film and the material of the plastic polymer reaction tube are both selected from the group of plastic polymers consisting of polypropylene, polystyrene, polyethylene, cycloolefin polymer (COP), cycloolefin copolymer (COC).

In a preferred embodiment the first layer of the heat weldable film is welded to the reaction tube. The heat weldable film may be welded to different positions at the reaction tube. The inventors unexpectedly found that the application of the heat weldable film onto the reaction tube is greatly facilitated if a cavity is provided into which the heat weldable film may be applied before the heat is applied to weld the film onto the reaction tube. This allows a precise predetermination of the exact position of the label onto the reaction tube. Hence, in one embodiment of the present invention the heat weldable film is placed in a cavity at the surface of the tube, wherein said cavity is at least partially surrounded by a rim. In a further embodiment the cavity is circumferentially surrounded by a rim. Furthermore, the inventors unexpectedly found that the edges of the heat weldable film are protected by the rim. This confers an even longer lifetime to the label on the reaction tube.

The height of the rim may be adapted to the needs and depends to the total thickness of the heat weldable film. In one embodiment the rim is higher than the total thickness of the heat weldable film. In another embodiment the rim is lower than the total thickness of the heat weldable film. In yet another embodiment the height of the rim is the same as the total thickness of the heat weldable film. It will he appreciated by the skilled person that “total thickness” of the film refers to the sum of thicknesses of the layers of the film. In a preferred embodiment of the reaction tube according to the present invention the rim has a height of between 0.01 mm and 5 mm, preferably of between 0.1 and 1 mm.

It will be appreciated by those of ordinary skills that the heat weldable film may also be used to label the vessels of a microplate. The most accessible part of the individual vessels is the bottom of each vessel. Hence, in one embodiment of the invention the first layer of the heat weldable film has been welded to the bottom of one or more vessels of the microplate. As outlined above it may be desirable to place the heat weldable film in a cavity on the surface of the reaction tube. For the same reasons it may also be desirable to place the heat weldable film into a cavity onto the surface of the microplate. Hence, in one embodiment of the microplate the heat weldable film is placed in a cavity at the surface of the tube, wherein said cavity is at least partially surrounded by a rim. The features of the to cavity, including the features of the rim as outlined above for the reaction tube, apply also to the cavity on the surface of the microplate.

The skilled artisan will acknowledge that by the present invention an easy labelling of reaction tubes or microplates is afforded. As outlined above the application of the heat is weldable film is facilitated if the heat weldable film is placed into a preformed cavity on the surface of the reaction tube or microplate. Hence, in one embodiment of the method and the reaction tube according to the present invention, the reaction tube comprises a cavity at least partially surrounded by a rim. In a further embodiment of the method according to the present invention said cavity is at the bottom of the reaction tube.

The invention further relates to the use of a heat weldable film according to the present invention for labelling plastic polymer reaction tubes.

The inventors found that the method according to the present invention is further facilitated if the reaction tube comprises a cavity in which the heat weldable film may be applied prior to welding, In a further embodiment of the method according to the present invention the heat weldable film is positioned in said cavity. Thereby the exact position may be predetermined. Furthermore, the inventors found that the procedure of applying the heat weldable film is unexpectedly even more facilitated if the heat weldable film has a size and shape that positively fits into said cavity, i.e. the sides of the heat weldable film are in contact with the rim. Thereby the heat weldable film is held in the desired position. Hence, in one embodiment of the present invention, the heat weldable film is held in said cavity prior to step (iii) through the said rim. This allows that in automated processes the means that apply the heat weldable film into said cavity can be exchanged by means for applying heat to the heat weldable film or alternatively the reaction tube can be transferred to another work station in which the heat is applied to heat weld the film onto the reaction tube. As the heat weldable film is held into position through the rims of said cavity, the risk that the heat weldable film slips off the desired position during transfer of the tubes or exchange of the means is minimized. Once this heat weldable film cooled, it is permanently bonded/welded to the tube. Furthermore, if the film is placed into a cavity at least partially surrounded by a rim the edge of the heat weldable film is protected by the raised rim of the cavity.

In a preferred embodiment the method according to the present invention comprises the steps of (i) providing a reaction tube comprising a cavity at least partially surrounded by a rim in a first work station comprising a punch tool; (ii) placing the heat weldable film according to the present invention into said cavity, wherein the first layer is faced towards the surface of the reaction tube, and wherein the heat weldable film positively fits into the is cavity formed by said rim; and wherein the heat weldable film is placed into the cavity by the punch tool; (iii) transferring the reaction tube comprising the heat weldable film into a second work station comprising a flat ended heat seal pin; (iv) applying heat and pressure onto the heat weldable film and/or the reaction tube through said heat seal pin for a time sufficient to weld the heat weldable film onto the reaction tube.

The methods according to the present invention are methods for producing bar-coded reaction tube. The bar code of the resulting reaction tube is on the heat weldable film. The present invention now provides the possibility to choose whether the bar code is created before or after welding the heat weldable film onto the tube. Hence, in one embodiment of the method according to the present invention, the heat weldable film comprises a bar code. However, it might be desirable that the bar code is applied onto the reaction tube later on, e.g. the customer may wish to individually label the reaction tube. Hence, in another embodiment of the present invention, the methods comprise a further step: providing a bar code onto the heat weldable film, preferably by means of laser technique. As outlined, this step may also be performed later, e.g. at the customer.

The skilled artisan will recognize that the methods according to the present invention may be applied to matrices comprising more than one reaction tube, e.g. for microplates or separate tubes that are arranged in matrices. The method may be performed for one tube at a time or for a plurality of tubes in parallel.

### EXAMPLES

### Example 1

### Production of A Heat Weldable Film

An opaque (second) layer comprising TiO₂ as a white pigment is provided onto 30 μm thick (third) layer consisting of polyester. An 8 μm thick foil of aluminium is applied onto the pigment layer through an adhesive. A 12 μm thick first layer consisting of polypropylene is thereafter applied onto the foil by a further adhesive.

### Applying the Heat Weldable Film Onto A Reaction Tube And Coding the Same

A disc having a diameter of 4 mm was cut from the produced heat weldable film. The disc was applied onto the surface of the bottom of a reaction tube consisting of polypropylene, wherein the (first) layer consisting of polypropylene was faced towards the surface of the reaction tubes. A temperature of 170° C. and a pressure of ˜200 g/cm² are applied onto the heat sealable film for 2 to 5 s. Thereafter a 2D code is applied onto the heat weldable film using a laser marking technique.

### Example 2

### Applying the Heat Weldable Film Into A Cavity On A Reaction Tube

A disc having a diameter of 4 mm was cut from the heat weldable film as outlined in Example 1. The disc is punched using a punch tool and the punch continues pushing down until it places the disc into the opening within the raised rim. The disc is sized so that there is a sufficient interference fit (positively fitted) between the disk and the rim so that the disk is held in place even after the punch has been withdrawn.

The tube is then transferred to a second work station where a fiat ended heat seal pin with a diameter fractionally smaller than the raised rim, is brought down in contact with the heat seal disk, heating the disc and thereby the polypropylene element sufficiently for it to bond/weld with the polypropylene of the tube base.

Once this heat seal pin is withdrawn and the disk cooled, the disk is permanently bonded/welded to the tube and the edge of the heat weldable film is protected by the raised rim of the cavity.

1. A heat weldable film comprising the following layers:
(i) a first plastic polymer layer consisting of a material weldable to a plastic polymer reaction tube;
(ii) an opaque second layer comprising pigments;
(in) a third layer consisting of a clear, transparent material;
wherein the material of the first and third layer differ.

2. The heat weldable film according to claim 1, wherein the heat weldable film comprises a machine readable code.

3. The heat weldable film according to claim 1, wherein the layers are bound together via adhesive layers and/or heat lamination.

4. The heat weldable film according to claim 1 further comprising a reflective foil between the first layer and the second layer.

5. The heat weldable film according to claim 4, wherein the foil has a thickness of between 0.001 mm and 0.05 mm, preferably of between 0.005 mm and 0.015 mm.

6. The heat weldable film according to claim 1, wherein the first layer consists of a material selected from the group consisting of polypropylene, polystyrene, polyethylene, cycloolefin polymer (COP), cycloolefin copolymer (COC).

7. The heat weldable film according to claim 1, wherein the first layer has a thickness of between 0.005 mm and 0.1 mm, preferably of between 0.01 mm and 0.030 mm.

8. The heat weldable film according to claim 1, wherein the third layer consists of a material selected from the group consisting of polyester, acrylic polymers and copolymers, vinyl halide polymers and copolymers, polycarbonates, and polyurethanes.

9. The heat weldable film according to claim 1, wherein the third layer has a thickness of between 0.001 mm and 0.1 mm, preferably of between 0.005 mm and 0.025 mm.

10. The heat weldable film according to claim 1, wherein the second layer comprises pigments selected from the group consisting of white pigments, preferably a pigment comprising titan dioxide (TiO₂).

11. A reaction tube comprising a heat weldable film according to claim 1, wherein the heat weldable film is welded to the reaction tube at the bottom of the tube.

12. The reaction tube according to claim 11, wherein the material of the reaction tube and the material of the first layer of the heat weldable film are the same materials.

13. The reaction tube according to claim 11, wherein the first layer of the heat weldable film is welded to the reaction tube.

14. The reaction tube according to claim 11, wherein the heat weldable film is placed in a cavity at the surface of the tube, wherein said cavity is at least partially surrounded by a rim.

15. The reaction tube according to claim 14, wherein the rim has a height of between 0.01 mm and 5 mm, preferably of between 0.1 mm and 1 mm.

16. A microplate comprising a heat weldable film according to claim 1, wherein the heat weldable film has been welded to the microplate.

17. The microplate according to claim 16, wherein the first layer of the heat weldable film has been welded to the bottom of one or more vessels of the microplate.

18. The microplate according to claim 16, wherein the heat weldable film is placed in a cavity at the surface of the tube, wherein said cavity is at least partially surrounded by a rim.

19. A method for producing a bar-coded reaction tube comprising the steps of:
(i) providing a reaction tube comprising a cavity at least partially surrounded by a rim;
(ii) placing the heat weldable film according to claim 1 into said cavity, wherein the first layer is faced towards the surface of the reaction tube;
(iii) applying heat and pressure onto the heat weldable film and/or the reaction tube for a time sufficient to weld the heat weldable film onto the reaction tube.

20. The method according to claim 19, wherein the heat weldable film is held in said cavity prior to step (iii) through said rim.
